(19) United States
(12) Patent Application Publication
(10) Pub. No.: US 2024/0198864 A1
(43) Pub. Date: Jun. 20, 2024

(54) Vehicle Seat Control System And Method Therefor

(71) Applicants: Hyundai Motor Company, Seoul (KR); Kia Corporation, Seoul (KR)

(72) Inventors: Yohan Kim, Ansan-si (KR); Munseung Kang, Suwon-si (KR); Kughun Han, Seoul (KR); Donghoon Lee, Seoul (KR)

(21) Appl. No.: 18/385,190

(22) Filed: Oct. 30, 2023

(30) Foreign Application Priority Data
Dec. 19, 2022 (KR) 10-2022-0178474

(51) Int. Cl. B60N 2/02; B60N 2/06; B60N 2/14; B60N 2/20; B60N 2/90; B60R 7/04

(52) U.S. Cl. CPC B60N 2/0252; B60N 2/02246; B60N 2/0272; B60N 2/06; B60N 2/14; B60N 2/20; B60N 2/995; B60R 7/04

(57) ABSTRACT

A vehicle seat control system includes: at least one seat comprising an one or more electronic devices for a seat sliding function, a backrest angle adjustment function, a leg-rest angle adjustment function, and a seat swivel function; a seat control module disposed in each seat to collect seat state data of the corresponding seat and control the functions of the one or more electronic devices based on an applied command; and a seat controller disposed to correspond to the seat control module, predicting an obstruction condition by another component during seat swivel by checking the seat state data if receiving a seat swivel request from a user, removing the obstruction condition through a pre-processing control by using the seat control module, and then performing a seat swivel control.

### CROSS-REFERENCE TO RELATED APPLICATION

This application claims priority to and the benefit of Korean Patent Application No. 10-2022-0178474 filed in the Korean Intellectual Property Office on Dec. 19, 2022, the entire contents of which are incorporated herein by reference.

### TECHNICAL FIELD

The present disclosure relates to a vehicle seat control system and a method therefor, and more particularly, to a vehicle seat control system for securing a space during seat swivel, and a method therefor.

### BACKGROUND

A vehicle seat may be provided with a motor to improve passenger convenience. For example, the following functions may be applied to the vehicle seat (e.g., based on a driver or passenger switch and/or control manipulation): a seat sliding/height adjustment function, a backrest angle adjustment function, a leg-rest angle adjustment function, or the like. A relax function to automatically adjust the seat to a neutral position and an easy access function to secure a space if a passenger gets on/off a vehicle may also be applied to the vehicle seat (e.g., in a one-touch mode, such as via a preprogrammed switch or setting) to improve the passenger comfort and convenience.

Meanwhile, the vehicle has added value as a resting or business space, in addition to being a convenient means of transportation, in accordance with the spread of an electric vehicle and the development of an autonomous driving technology.

Also, or alternatively, the leg rest function mainly applied to a rear (or second row) seat, has recently been expanded to a front (or first-row) seat due to expansion of an interior space of an electric vehicle platform, and it is thus necessary to develop multi-faceted technologies to realize the space in consideration of the two technologies together.

However, the seat may occupy a large proportion in the vehicle, and there are many cases where the seat is obstructed by another component during its movement. Accordingly, operation of the seat swivel function may have a restriction, which may cause a user to feel uncomfortable if manipulating the seat.

Also, or alternatively, in a case where an organic space is secured by simply reducing sizes of the seat and a center console to operate the seat swivel function, it is inevitable to reduce existing seat functions to improve the passenger convenience, which may cause customer dissatisfaction.

The above information disclosed in this Background section is provided only to assist in better understanding of the background of the present disclosure, and may thus include information not included in the prior art already known to those skilled in the art to which the present disclosure pertains.

### SUMMARY

The following summary presents a simplified summary of certain features. The summary is not an extensive overview and is not intended to identify key or critical elements.

Systems, apparatuses, and methods are described for a controlling a vehicle seat. A vehicle seat control system may comprise a seat comprising at least one electronic device configured to perform a plurality of functions comprising: a seat sliding function, a backrest angle adjustment function, a leg-rest angle adjustment function, and a seat swivel function; a seat control module, for the seat, configured to collect seat state data and to control, based on a received command, the at least one electronic device to perform at least one of the plurality of functions; and a seat controller, communicatively connected to the seat control module. The seat controller may be configured to predict an obstruction condition of a seat swivel by checking, based on receiving a request for the seat swivel, the seat state data; resolve the obstruction condition via a pre-processing control of the seat control module; and based on the obstruction condition being resolved, cause the seat control module to control the at least one electronic device to perform the seat swivel via the seat swivel function.

A method for a vehicle seat control may comprise checking, based on receiving a signal indicating user input requesting to swivel a seat, seat state data of the seat; determining, based on the seat state data, whether a plurality of conditions, comprising preset conditions of a closed leg rest and the seat at a target position, are satisfied; based on at least one of the plurality of conditions not being satisfied: determining an obstruction condition for performing a seat swivel function, and performing a pre-processing control to remove the obstruction condition; and based on the performing the pre-processing control and the plurality of conditions being satisfied, performing a swivel control to swivel the seat to a preset angle via the seat swivel function.

These and other features and advantages are described in greater detail below.

### BRIEF DESCRIPTION OF THE DRAWINGS

FIG. 1 schematically shows a vehicle seat control system according to a first example of the present disclosure.

FIG. 2 schematically shows a configuration of a seat controller according to the first example of the present disclosure.

FIG. 3 shows a pre-processing control state for a seat swivel function according to the first example of the present disclosure.

FIGS. 4 and 5 respectively show a flow chart showing a method for a vehicle seat control according to the first example of the present disclosure, and a seat state in each control step.

FIG. 6 schematically shows a vehicle seat control system according to a second example of the present disclosure.

FIGS. 7 and 8 respectively show a flow chart showing a method for a vehicle seat control according to the second example of the present disclosure, and a seat state in each control step.

FIG. 9 schematically shows a vehicle seat control system according to a third example of the present disclosure.

FIGS. 10 and 11 respectively show a flow chart showing a method for a vehicle seat control according to the third example of the present disclosure, and a seat state in each control step.

FIGS. 12 and 13 respectively show a flow chart showing a method for a vehicle seat control according to a fourth example of the present disclosure, and a seat state in each control step.

### DETAILED DESCRIPTION OF THE EXAMPLES

Hereinafter, examples of the present disclosure are described in detail with reference to the accompanying drawings for those skilled in the art to which the present disclosure pertains to easily practice the present disclosure.

A term used herein is only to describe a specific example, and is not intended to limit the present disclosure. A term of a singular number used herein is intended to include its plural number unless the context clearly indicates otherwise. It should also be understood that the terms “include,” “have,” “comprise” and/or variations thereof, as used in the specification, specify the presence of the features, integers, steps, operations, elements and/or components, and do not exclude the presence or addition of one or more of other features, integers, steps, operations, elements, components, and/or groups thereof. The term “and/or” used herein includes any one or all combinations of the associated listed items.

Terms such as “first,” “second,” A, B, (a), (b), 1, 2, and the like, may be used to describe various components throughout the specification, and these components are not to be construed as being limited by these terms. These terms are only used to distinguish any component from another component, and the features, sequences, and the like of the corresponding components are not limited by these terms.

It is to be understood that if one component is referred to as being “connected to” or “coupled to” another component, the one component may be connected directly to or coupled directly to the other component, or connected to or coupled to the other component with still one or more other component interposed therebetween. On the other hand, it is to be understood that if one component is referred to as being “connected directly to” or “coupled directly to” another component, the one component is connected to or coupled to the other component without still another component interposed therebetween.

Further, it is to be understood that one or more of methods described below or aspects thereof may be executed by at least one or more controllers. The term “controller” may refer to a hardware device including a memory and a processor. The memory may store program instructions, and the processor may be configured to execute the program instructions, which may cause performance of one or more processes described below in more detail. The controller may control operations of units, modules, components, devices, or the like, as described herein. It is also to be understood that the methods described below may be executed by an apparatus including the controller in conjunction with one or more other components, as appreciated by those skilled in the art.

Hereinafter, the description describes a vehicle seat control system and a method therefor according to the examples of the present disclosure in detail with reference to the accompanying drawings.

### FIRST EXAMPLE

A vehicle seat control system according to the first example may be configured to secure a space for smooth seat swivel in a vehicle equipped with an electric seat and a fixed console.

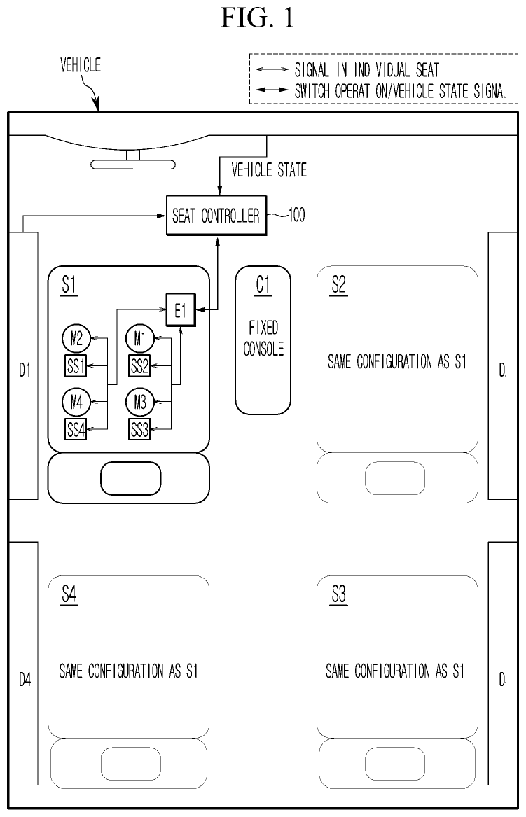

FIG. 1 schematically shows the vehicle seat control system according to the first example of the present disclosure. The vehicle seat control system may include at least one seat (e.g., seat S1, S2, S3, or S4) including one or more electronic devices (e.g., comprising one or more motors, such as motors M1, M2, M3, or M4) for performing a seat sliding function, a backrest angle adjustment function, a leg-rest angle adjustment function, and/or a seat swivel (alternatively referred to as seat rotation) function. A seat control module E1 may be provided for (e.g., disposed in/on) the a seat S1, S2, S3, or S4 to collect seat state data of the seat S1, S2, S3, or S4 and control the functions of the one or more electronic devices based on an received command. A seat controller 100 may be communicatively connected to the seat control module E1, and may be configured to determine and/or predict an obstruction condition (or situation) by another component during seat swivel by checking the seat state data based on receiving a seat swivel request from a user. The seat controller may be configured to remove the obstruction condition (e.g., via a pre-processing control) by using the seat control module E1, and then performing a seat swivel control.

A center console may be disposed between the front seats S1 and S2 (e.g., between a driver seat and a passenger seat) of a vehicle. In the presently described first example relates to a fixed console C1 disposed as the center console.

The one or more electronic devices may be included in the first seat S1 (e.g., the driver seat) and/or the second seat S2 (e.g., the front passenger seat), and/or may be disposed as each or any of the seats S1, S2, S3, and S4.

The vehicle may be a passenger vehicle having two-rows or more seats, a sports utility vehicle (SUV), an electric vehicle, and/or the like. An autonomous driving function may be applied to the vehicle. The vehicle may include a plurality of doors, such as illustrated D1, D2, D3, and D4, allowing the user to get on/off the vehicle by respectively being opened and/or closed corresponding to positions of the seats S1, S2, S3, and S4. One of more of the plurality of doors D1, D2, D3, and D4 (e.g., each of the plurality of doors D1, D2, D3, and D4) may transmit data indicating opening and/or closing to the seat controller 100 (e.g., via a sensor). One or more of (e.g., each of) the plurality of doors D1, D2, D3, and D4 may be a pillarless door and/or a door omitting a B-pillar, to utilize an interior space of the vehicle.

The one or more electronic devices may include a plurality of motors M1, M2, M3, and M4 for performing the functions of the seat. The plurality of motors M1, M2, M3, and M4 may be configured to perform the functions based on a control signal applied thereto. A plurality of sensors SS1, SS2, SS3, and SS4 may each be configured to determine (e.g., identify) a position of one or more corresponding motors of the plurality of motors M1, M2, M3, and M4.

A first motor M1 may be operated for the seat sliding function (e.g., based on the control signal). The first motor M1 may include and/or be communicatively connected to a first sensor SS1 configured to measure a position of the first motor M1. The first motor M1 may move the seat forward (+) or backward (−) along a slide rail.

A second motor M2 may be operated for the backrest angle adjustment function (e.g., based on a control signal). The second motor M2 may include and/or be communicatively connected to a second sensor SS2 configured to measure a position of the second motor M2.

A third motor M3 may be operated for the leg-rest angle adjustment function (e.g., based on a control signal). The third motor M3 may include a third sensor SS3 configured to measure a position of the third motor M3.

A fourth motor M4 may be operated for the seat swivel function (e.g., based on a control signal). The fourth motor M4 may include the fourth sensor SS4 configured to measure a position of the fourth motor M4.

The fourth motor M4 may be configured to swivel-switch a seat direction by swiveling the corresponding seat to various angles and/or directions (e.g., based on the control signal). For example, the fourth motor M4 may swivel the seat in the seat direction so as to provide the user with a front view, a side view, and/or a rear view based on the control signal.

Each of the sensors SS1, SS2, SS3, and SS4 applied to the seats S1, S2, S3, and S4 may comprise a Hall sensor and/or an encoder. The sensors SS1, SS2, SS3, and SS4 may measure the position of the corresponding motor in which the sensor is installed and/or with which the sensor is in communication. Here, measuring the position of the corresponding motor by each sensor SS1, SS2, SS3, or SS4 may comprise measuring and/or determining a position at which a subject of the corresponding operation is operated. Therefore, the first sensor SS1 may measure a seat movement position based on the operation of the first motor M1, the second sensor SS2 may measure a backrest angle based on the operation of the second motor M2, the third sensor SS3 may measure a leg rest angle based on the operation of the third motor M3, and the fourth sensor SS4 may measure a seat-swivel angle based on the operation of the fourth motor M4.

The seat control module E1 may collect a measurement value of one or more of (e.g., each of) the seat sensors SS1, SS2, SS3, and SS4, and/or identify the state data including at least one of the leg rest angle, backrest angle, seat slide position, and seat swivel angle of the corresponding seat based thereon.

The seat control module E1 may control the function of the corresponding seat based on a user input signal and/or a seat manipulation signal received from the seat controller 100, collect the last state data measured by each sensor after performing the above control, and transfer the same to the seat controller 100.

The seat control module E1 may allow the seat controller 100 to manage current state data of the seat by controlling the operation of at least one of the plurality of motors M1, M2, M3, and M4 based on the input signal, collect the last state data of each component from at least one of the plurality of seat sensors SS1, SS2, SS3, and SS4, and transmit the same to the seat controller 100.

The seat controller 100 may control an overall operation of the seat so as to prevent the obstruction of swiveling of the seat by another component. The seat controller 100 may control the operation based on the state data collected by the seat control module E1 during the vehicle seat swivel according to the example of the present disclosure.

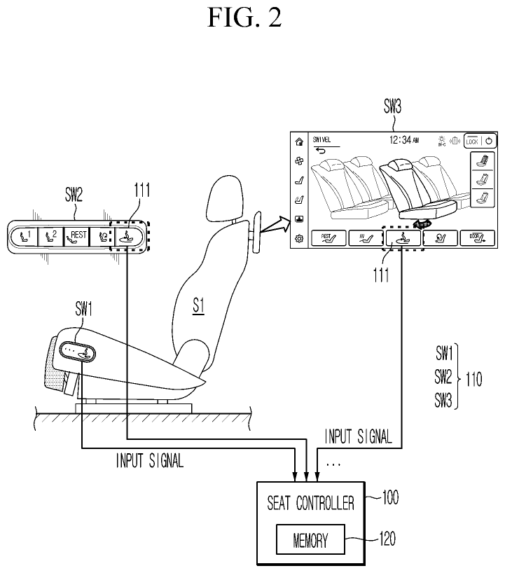

FIG. 2 schematically shows a configuration of the seat controller according to the first example of the present disclosure.

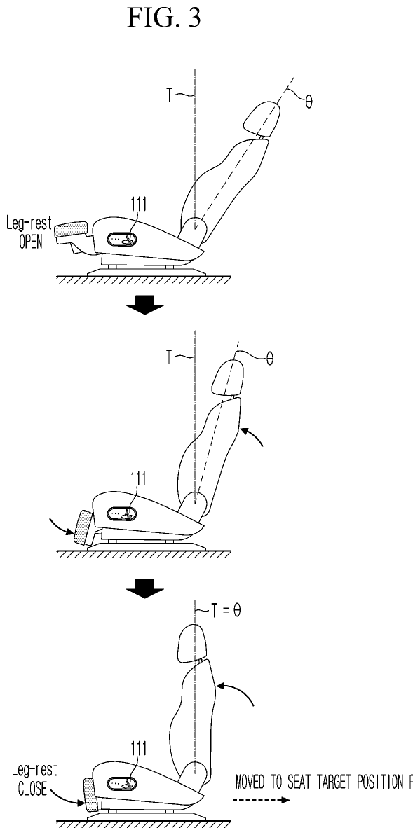

FIG. 3 shows a pre-processing control state for the seat swivel function according to the first example of the present disclosure.

Referring to FIGS. 2 and 3, the seat controller 100 according to the example of the present disclosure may store, in a memory 120, at least one program and data for controlling a seat input device 110 for a user seat manipulation and the corresponding seat (hereinafter referred to as S1). For example, the seat controller 100 may set a seat target position P1, a target leg rest angle (e.g., zero degrees relative to vertical), a target backrest angle T, the swivel angle, and/or the like, for moving the seat S1 as much as the seat S1 may not be obstructed by the fixed console C1 during its swivel, and store the same in the memory 120. The target backrest angle T refers to its angle erected toward the seat and/or a cushion of the seat.

The seat input device 110 may include a physical switch SW1 or SW2 disposed in the vehicle, a display AVN in the vehicle, and/or a digital switch SW3 installed in a user terminal application (APP). It is also possible to input a voice command by using the ANV and/or the APP.

The seat controller 100 is a higher-level controller controlling an overall operation of the seat S1 by transmitting an operation command to the corresponding seat control module E1 based on the input signal of the seat input device 110 based on the user manipulation and/or a preset control condition (e.g., door-interlock easy access function). Therefore, it is to be understood that the seat control module E1 controls the function of the seat S1 actually by the operation command of the seat controller 100 in practice.

The seat controller 100 may manage the current state data of the seat S1 in real time by controlling the function of the seat S1, and then updating the last (or latest) state data received from the seat control module E1 in the memory 120. Also, or alternatively, the seat controller 110 may collect the state data in real time from the seat control module E1 and the sensors (alternatively, the doors or the like) in the vehicle.

The seat controller 100 may identify the state data of the seat S1 if receiving the input signal (i.e., seat swivel request signal) of a seat swivel switch 111 of the seat input device 110. Also, or alternatively, the seat controller 100 may perform the pre-processing control to close a leg rest of the seat S1 through the leg-rest angle adjustment function if the leg rest is opened (e.g., raised), and/or move the seat S1 to a seat target position P1, at which the seat S1 may be swiveled in a vehicle interior, via the front/rear seat sliding function, and then perform the swivel control to swivel the seat S1 at a set angle through the seat swivel function. The pre-processing control may indicate a pre-control to remove the surrounding obstruction condition (or situation) before performing the swivel control of the seat S1 (see FIG. 3).

Also, or alternatively, the pre-processing control may further include controlling the seat S1 to have the target angle T through the backrest angle adjustment function of the seat S1.

As such, the seat controller 100 may check the state data of the seat S1 upon receiving the seat swivel request, reduce a swivel radius of the seat S1 as much as possible through the pre-processing control, and move the seat S1 to the target position to thus secure a sufficient swivel space, thereby preventing the obstruction by the surrounding component.

The swivel control may adjust the seat S1 in various directions (e.g., clockwise and/or counterclockwise) and at various angles to provide the user with the front view, the side view, and/or the rear view. The swivel control may finely adjust the angle based on the time and/or operation amount of the seat swivel switch 111 if pressed by the user.

Also, or alternatively, the swivel control may perform one-touch adjustment of the switch disposed based on the preset angle and direction. For example, the seat controller 110 may perform mutual swivel control of the seat to provide the user with the front view, the side view, and/or the rear view with one touch. This control may be implemented by referring to the contents described above.

The seat controller 100 may be implemented as at least one processor operated based on a set program, and the set program may be programmed to perform each step of a method for a vehicle seat control according to the example of the present disclosure.

The method for the vehicle seat control is described in more detail with reference to the drawings below.

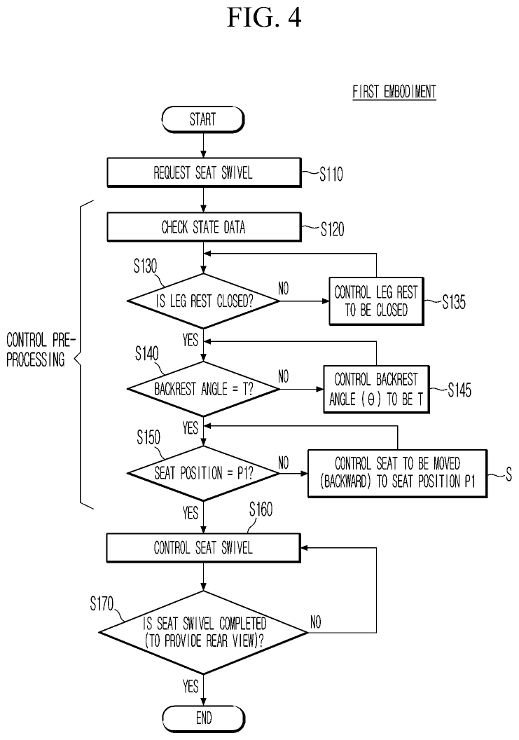

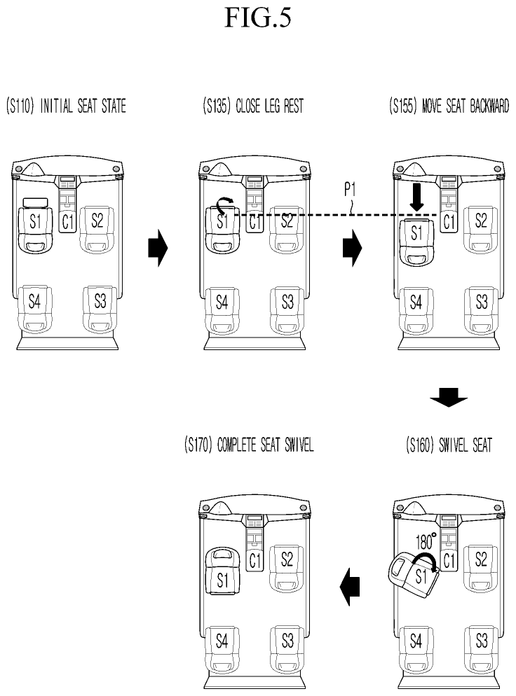

FIGS. 4 and 5 respectively show a flow chart showing the method for the vehicle seat control according to the first example of the present disclosure, and a seat state in each control step.

Referring to FIGS. 4 and 5, the description describes the method for the vehicle seat control according to the first example of the present disclosure by assuming a scenario in which the swivel function of the seat S1 is operated in an initial seat state where the seat provides the front view.

If receiving a signal requesting swivel of the seat S1 based on the user input of the seat swivel switch 111 (S110), the seat controller 100 may check the state data of the seat S1 (S120).

Here, the seat controller 100 may collect the state data including at least one of the leg rest angle, the backrest angle, the seat slide position, and the seat-swivel angle to thus identify whether all the preset conditions of the leg rest closing, the backrest target angle T, and the seat target position P1 are satisfied. Also, or alternatively, if there is an unsatisfied condition, the seat controller 100 may perform the pre-processing control to remove the obstruction condition by predicting the obstruction condition in operating the seat swivel function.

For example, the seat controller 100 may identify whether the leg rest angle of the seat S1 is closed (S130), and if the leg rest angle is not closed (No in S130), the seat controller 100 may control the leg rest to be closed (or have the zero degrees) through the leg-rest angle adjustment function (S135).

The seat controller 100 may identify whether the backrest angle of the seat S1 is the backrest target angle T (S140), and if the backrest angle is not the backrest target angle T (No in S140), the seat controller 100 may control a backrest to the set target angle through the backrest angle adjustment function (S145).

The seat controller 100 may identify whether the seat slide position of the seat S1 is the seat target position P1 (S150), and if the seat slide position is not the seat target position P1 (No in S150), the seat controller 100 may control the seat S1 to be moved backward to the seat target position P1 through the seat sliding function (S155).

If all the conditions of the leg rest closing, backrest target angle, and seat target position P1 of the seat S1 are satisfied through the pre-processing control (Yes in all of S130, S140, and S150), the seat controller 100 may perform the swivel control to swivel the target seat at a preset angle through the seat swivel function (S160).

The seat controller 100 may continue the seat swivel control (No in S170) until the seat-swivel angle collected in the state data reaches a swivel setting angle (for providing the rear view for example), and end the corresponding control if the seat-swivel angle reaches the swivel setting angle and the seat swivel is completed (or the seat provides the rear view) (Yes in S170).

Here, the seat controller 100 may manage the current state data of all the seats by completing the seat swivel control of the seat S1, and then updating the last state data received from the seat control module E1 in the memory 120.

Then, if receiving a swivel signal requesting return of the seat S1 by the user, the seat controller 100 may remove the obstruction condition by performing the pre-processing control in the same way as described above, and then performing the swivel control to swivel the seat to provide the front view through the seat swivel function.

Hereinabove, the description describes the vehicle seat control system and a method therefor according to the first example of the present disclosure. However, the examples of the present disclosure are not limited thereto, and include various other modifications.

For example, the fixed console C1 is described in the first example of the present disclosure with reference to FIG. 1. However, the examples of the present disclosure are not limited thereto, and use a manual console C2 and/or an electric console C3, which may be moved forward/backward.

Therefore, the description describes hereinafter a vehicle seat control system using the manual console C2 and/or the electric console C3 and a method therefor through various examples of the present disclosure.

### SECOND EXAMPLE

A vehicle seat control system according to the second example of the present disclosure provides a technology for securing a space for smooth seat swivel of a vehicle where an electric seat and a manual console capable of being moved forward/backward are disposed.

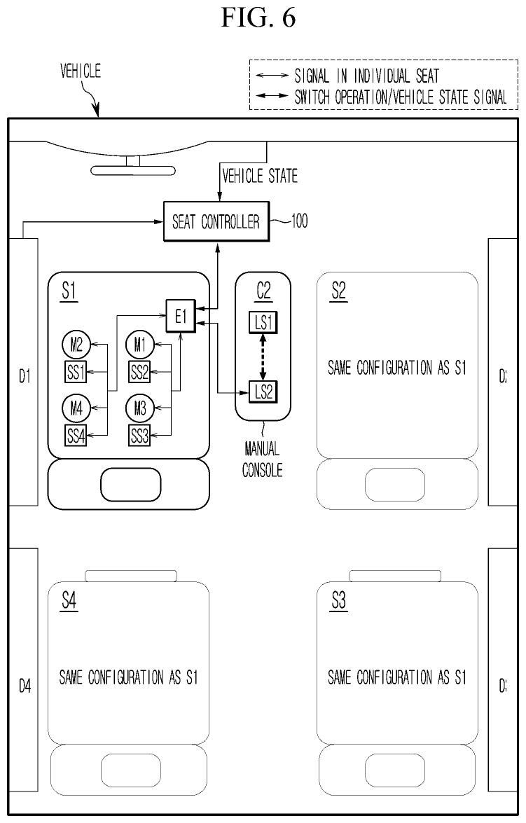

FIG. 6 schematically shows the vehicle seat control system according to the second example of the present disclosure.

Referring to FIG. 6, the vehicle seat control system according to the second example of the present disclosure may include: at least one seat S1, S2, S3, or S4 including one or more electronic devices for a seat sliding function, a backrest angle adjustment function, a leg-rest angle adjustment function, and a seat swivel function; a manual console C2 disposed between the front seats S1 and S2 and capable of being moved forward/backward, and limit sensors LS1 and LS2 each detecting a position of the manual console C2; a seat control module E1 disposed in each seat S1, S2, S3, or S4 to collect seat state data of the corresponding seat and control the functions of the one or more electronic devices based on an applied command; and a seat controller 100 disposed to correspond to the seat control module E1, predicting an obstruction condition by another component including the manual console C2 during seat swivel by checking the seat state data of the seat and further checking the position of the manual console C2 if receiving a seat swivel request from a user, removing the obstruction condition through a pre-processing control by using the seat control module E1, and then performing a seat swivel control.

The configuration of the vehicle seat control system in the second example of the present disclosure is similar to the configuration of the vehicle seat control system in the first example described above, except for that this system includes the manual console C2 instead of the fixed console C1. Therefore, in describing the second example of the present disclosure, descriptions similar to those of the first example are omitted and descriptions focusing on different points are provided.

The manual console C2 may be moved forward and/or backward along a slide rail by the user. The slide rail may include the first limit sensor LS1 disposed foremost (e.g., at or near a front end of the slide rail) and/or the second limit sensor LS2 disposed rearmost (e.g., at or near a rear end of the slide rail). For example, the first limit sensor LS1 and/or the second limit sensor LS2 may detect the position of the manual console C2 if contacted and/or pressed by the manual console C2.

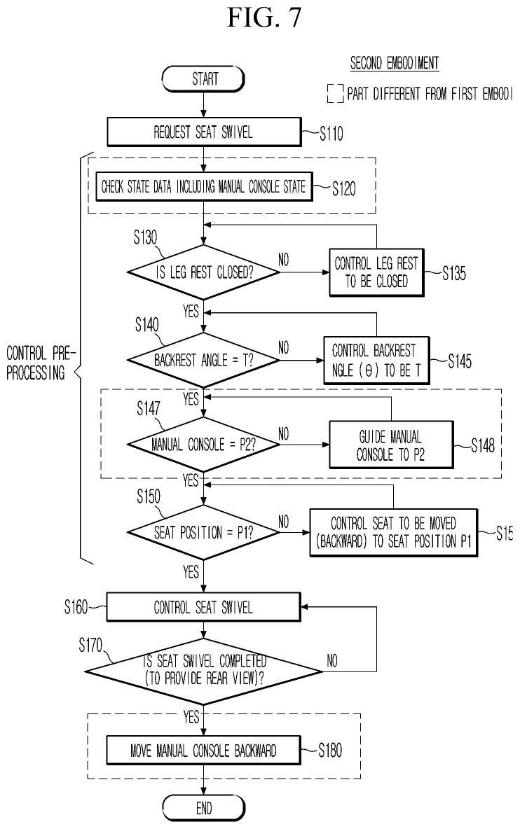

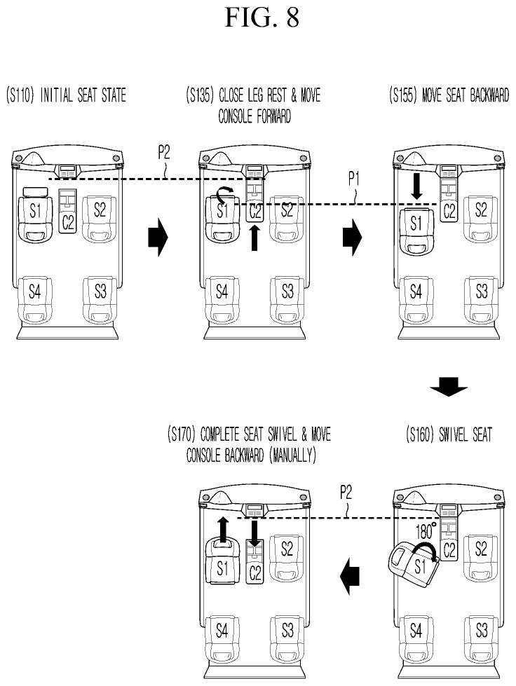

FIGS. 7 and 8 respectively show a flow chart showing a method for a vehicle seat control according to the second example of the present disclosure, and a seat state in each control step.

Referring to FIGS. 7 and 8, the description describes the method for the vehicle seat control according to the second example of the present disclosure by assuming a scenario in which the swivel function of the seat S1 is operated in an initial seat state where the seat provides the front view.

If receiving a signal requesting swivel of the seat S1 based on the user input of the seat swivel switch 111 (S110), the seat controller 100 may check the state data of the seat S1 and the manual console C2 (S120).

Here, the seat controller 100 may collect the state data including at least one of the leg rest angle, the backrest angle, the position of the manual console C2, the seat slide position, and the seat-swivel angle to thus identify whether all the conditions of the leg rest closing, the backrest target angle, a manual console target position P2, and the seat target position P1 are satisfied. Also, or alternatively, if there is an unsatisfied condition, the seat controller 100 may perform the pre-processing control to remove the obstruction condition in operating the seat swivel function.

For example, the seat controller 100 may identify whether the leg rest angle of the seat S1 is closed (S130), and if the leg rest angle is not closed (No in S130), the seat controller 100 may control the leg rest to be closed (or have the zero degrees) through the leg-rest angle adjustment function (S135).

The seat controller 100 may identify whether the backrest angle of the seat S1 is the backrest target angle (S140), and if the backrest angle is not the backrest target angle T (No in S140), the seat controller 100 may control the backrest to the set target angle through the backrest angle adjustment function (S145).

The seat controller 100 may identify whether the position of the manual console C2 is the foremost console target position P2 (S147). While a foremost console target position is discussed herein, another console target position may be contemplated, (e.g., a rearmost target position, an intermediate target position, based on a structure of the console C2 and/or a space used by the seat S1 while swiveling). If the position of the manual console C2 is not the console target position P2 (No in S147), the seat controller 100 may guide the user to move the manual console C2 to the console target position P2 (S148). The guide may be expressed as a guide comment and/or graphics using the display in the vehicle, and/or another display and/or communication device accessible to the user. Here, the fact that the position of the manual console C2 is not the console target position P2 refers to a situation where the manual console C2 is moved backward and in use based on user need. In this situation, the seat swivel of the seat S1 may be obstructed by the manual console C2 even though the seat S1 is moved to the seat target position P1 and then swiveled, and the seat controller 100 may guide the user to use the manual console C2.

The seat controller 100 may identify whether the seat slide position of the seat S1 is the seat target position P1 (S150), and if the seat slide position is not the seat target position P1 (No in S150), the seat controller 100 may control the seat S1 to be moved backward to the seat target position P1 through the seat sliding function (S155).

If all the conditions of the leg rest closing, backrest target angle, console target position P2, and seat target position P1 of the seat S1 are satisfied through the pre-processing control (Yes in all of S130, S140, S147, and S150), the seat controller 100 may perform the swivel control to swivel the seat S1 at a preset angle through the seat swivel function (S160). However, if any one of the above conditions is not satisfied, the seat controller 100 may stop the seat swivel control for safety, and inform the driver of a reason for the stop.

The seat controller 100 may continue the seat swivel control (No in S170) until the seat-swivel angle collected in the state data reaches a swivel setting angle (for providing the rear view for example), and end the corresponding control if the seat-swivel angle reaches the swivel setting angle and the seat swivel is completed (or the seat provides the rear view) (Yes in S170).

Here, after completing the seat swivel, the manual console C2 may be moved backward by the user to be used as a table (S180).

Then, if receiving a swivel signal requesting return of the seat S1 by the user, the seat controller 100 may remove the obstruction condition by performing the pre-processing control in the same way as described above, and then switch the seat to provide the front view through the seat swivel function.

### THIRD EXAMPLE

A vehicle seat control system according to the third example of the present disclosure provides a technology for securing a space for smooth seat swivel of a vehicle where an electric seat and an electric console capable of being moved forward/backward are disposed.

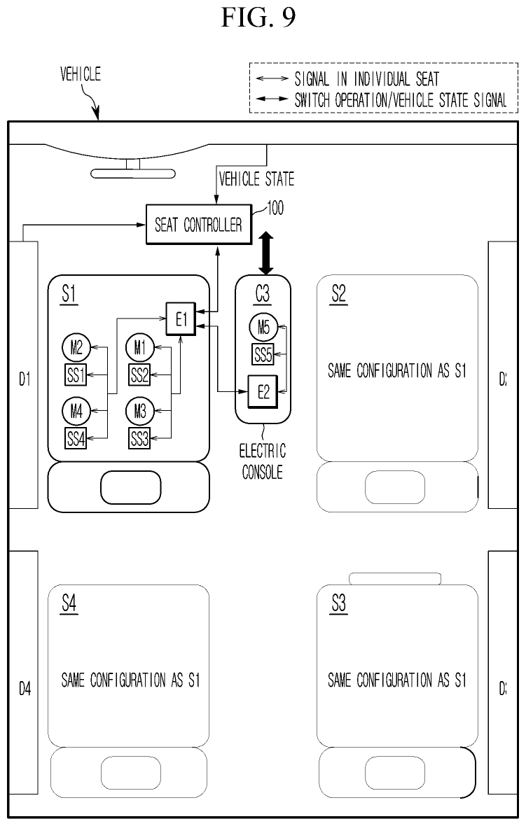

FIG. 9 schematically shows a vehicle seat control system according to the third example of the present disclosure.

Referring to FIG. 9, the vehicle seat control system according to the third example of the present disclosure may include: at least one seat S1, S2, S3, or S4 including one or more electronic devices for a seat sliding function, a backrest angle adjustment function, a leg-rest angle adjustment function, and a seat swivel function; an electric console C3 disposed between the front seats S1 and S2 and capable of being moved forward/backward, and a console position sensor M5 detecting a position of the electric console C3; a seat control module E1 disposed in each seat S1, S2, S3, or S4 to collect seat state data of the corresponding seat and control the functions of the one or more electronic devices based on an applied command; and a seat controller 100 predicting an obstruction condition by another component including the electric console C3 during seat swivel by checking the seat state data of the seat and further checking the position of the electric console C3 if receiving a seat swivel request from a user, removing the obstruction condition through a pre-processing control by using the seat control module E1, and then performing a seat swivel control.

The configuration of the vehicle seat control system in the third example of the present disclosure is similar to the configuration of the vehicle seat control system in the first or second examples described above, except for that this system includes the electric console C3 instead of the fixed console C1 or the manual console C2. Therefore, in describing the third example of the present disclosure, descriptions similar to those of the first or second examples are omitted and descriptions focusing on different points are provided.

The electric console C3 may be moved forward and/or backward along the slide rail by using the console motor M5 operated based on the control signal, and include a console sensor SS5 measuring the position of the console motor M5.

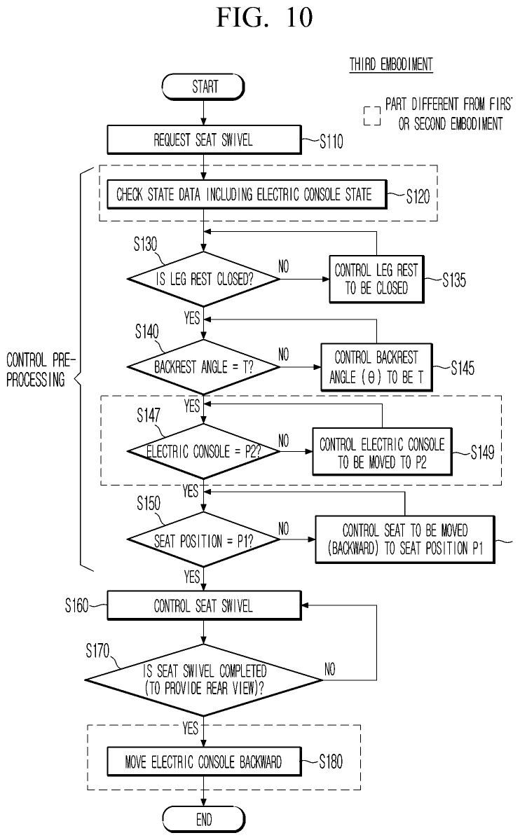

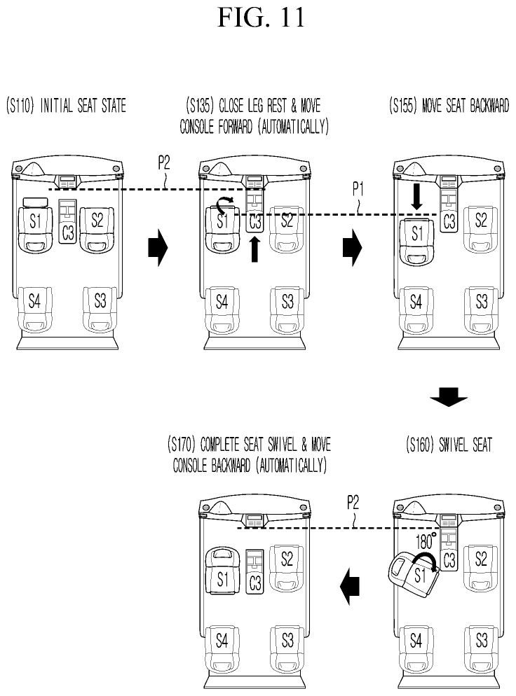

FIGS. 10 and 11 respectively show a flow chart showing a method for a vehicle seat control according to the third example of the present disclosure, and a seat state in each control step.

Referring to FIGS. 10 and 11, the description describes the method for the vehicle seat control according to the third example of the present disclosure by assuming a scenario in which the swivel function of the seat (e.g., S1) is operated in an initial seat state where the seat provides the front view.

If receiving a signal requesting swivel of the seat S1 based on the user input of the seat swivel switch 111 (S110), the seat controller 100 may check the state data of the corresponding seat S1 and the electric console C3 (S120).

Here, the seat controller 100 may collect the state data including at least one of the leg rest angle, the backrest angle, the position of the electric console C3, the seat slide position, and the seat-swivel angle to thus identify whether all the conditions of the leg rest closing, the backrest target angle, an electric console target position P2, and the seat target position P1 are satisfied. Also, or alternatively, if there is an unsatisfied condition, the seat controller 100 may perform the pre-processing control to remove the obstruction condition in operating the seat swivel function.

For example, the seat controller 100 may identify whether the leg rest angle of the seat S1 is closed (S130), and if the leg rest angle is not closed (No in S130), the seat controller 100 may control the leg rest to be closed (or have the zero degrees) through the leg-rest angle adjustment function (S135).

The seat controller 100 may identify whether the backrest angle of the seat S1 is the backrest target angle (S140), and if the backrest angle is not the backrest target angle T (No in S140), the seat controller 100 may control the backrest to the set target angle through the backrest angle adjustment function (S145).

The seat controller 100 may identify whether the position of the electric console C3 is the foremost console target position P2 (S147), and if the position of the electric console C3 is not the console target position P2 (No in S147), the seat controller 100 may control the electric console C3 to be moved to the console target position P2 through a console controller E2 (S149).

The seat controller 100 may identify whether the seat slide position of the seat S1 is the seat target position P1 (S150), and if the seat slide position is not the seat target position P1 (No in S150), the seat controller 100 may control the seat S1 to be moved backward to the seat target position P1 through the seat sliding function (S155).

If all the conditions of the leg rest closing, backrest target angle, console target position P2, and seat target position P1 of the seat S1 are satisfied through the pre-processing control (Yes in all of S130, S140, S147, and S150), the seat controller 100 may perform the swivel control to swivel the seat S1 at a preset angle through the seat swivel function (S160). However, if any one of the above conditions is not satisfied, the seat controller 100 may stop the seat swivel control for safety, and inform the driver of a reason for the stop.

The seat controller 100 may continue the seat swivel control (No in S170) until the seat-swivel angle collected in the state data reaches a swivel setting angle (for providing the rear view for example), and end the corresponding control if the seat-swivel angle reaches the swivel setting angle and the seat swivel is completed (or the seat provides the rear view) (Yes in S170).

Here, the seat controller 100 may dispose the electric console C3 at its immediately-previous usage position by controlling the electric console C3 moved to the console target position P2 to be moved backward after completing the seat swivel (S180).

Then, if receiving a swivel signal requesting return of the seat S1 by the user, the seat controller 100 may remove the obstruction condition by performing the pre-processing control in the same way as described above, and then switch the seat to provide the front view through the seat swivel function.

### FOURTH EXAMPLE

The fourth example of the present disclosure may use the vehicle seat control system according to any one of the first to third examples, and provides a technology for securing a space from a pillar trim, a door trim, and/or the like if swivel of the electric seat is controlled to thus provide the user with the side view toward the outside of the vehicle.

The user may intend to install a child seat on the seat providing the side view toward the outside (or the door) of the vehicle. In this case, it may be difficult for the user to approach the corresponding seat and install the child seat if the leg rest is opened. Also, or alternatively, the leg rest may be opened if the passenger gets on/off the vehicle while the seat provides the side view. In this case, it may be difficult for the user to put user feet on a floor of the vehicle. Also, or alternatively, if swiveled to thus provide the side view toward the outside of the vehicle, the seat is may be obstructed by the pillar, the door trim, and/or the like.

Accordingly, the fourth example of the present disclosure aims to secure a space from the pillar trim, the door trim, and/or the like if the swivel of the electric seat is controlled to thus provide the side view toward the outside of the vehicle.

The seat controller 100 may perform a side view control to swivel the seat toward the outside of the vehicle in conjunction with the door D1 of the vehicle and the seat control module E1.

The door D1 may transmit the state data on its opening and/or closing to the seat controller 100 through the sensor. Each of the plurality of doors D1, D2, D3, and D4 may be the pillarless door omitting the B-pillar to utilize the interior space of the vehicle.

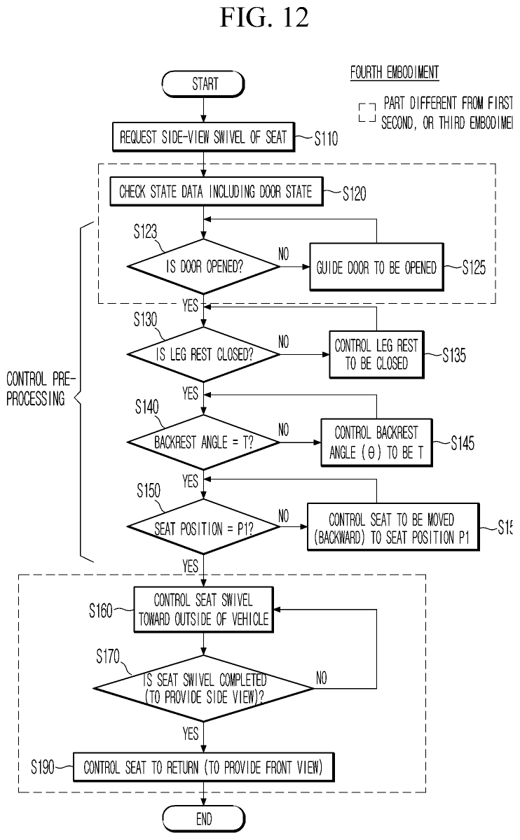

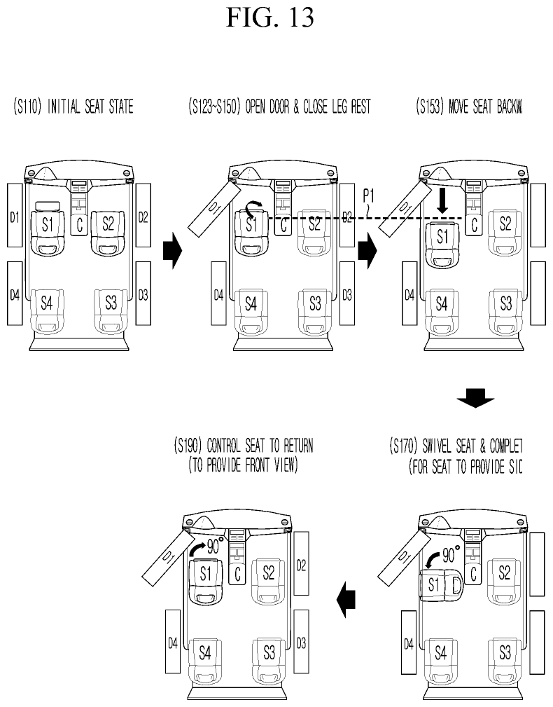

FIGS. 12 and 13 respectively show a flow chart showing a method for a vehicle seat control according to the fourth example of the present disclosure, and a seat state in each control step.

Referring to FIGS. 12 and 13, the description describes the method for the vehicle seat control according to the fourth example of the present disclosure by assuming a scenario in which the swivel function of the seat S1 for providing the side view is operated in an initial seat state where the seat provides the front view.

If receiving a signal requesting side-view swivel of the seat S1 based on the user input of the seat swivel switch 111 (S110), the seat controller 100 may check the state data of the seat S1 and the corresponding door D1 (S120).

Here, the seat controller 100 may collect the state data including at least one of a door state, the leg rest angle, the backrest angle, the seat slide position, the position of the center console, and the seat-swivel angle to thus identify whether all the conditions of the door opening, the leg rest closing, the backrest target angle, and the seat target position P1 are satisfied. Also, or alternatively, if there is an unsatisfied condition, the seat controller 100 may perform the pre-processing control to remove the obstruction condition in operating the seat swivel function.

For example, the seat controller 100 may identify whether the door D1 corresponding to the seat S1 is opened (S123), and if the door D1 is not opened (No in S123), the seat controller 100 may guide the user to open the door D1 (S125). That is, the seat controller 100 may perform a process of switching the seat S1 to provide the side view while the door D1 corresponding to the seat S1 is opened.

The seat controller 100 may identify whether the leg rest angle of the seat S1 is closed (S130), and if the leg rest angle is not closed (No in S130), the seat controller 100 may control the leg rest to be closed (or have the zero degrees) through the leg-rest angle adjustment function (S135).

The seat controller 100 may identify whether the backrest angle of the seat S1 is the backrest target angle (S140), and if the backrest angle is not the backrest target angle T (No in S140), the seat controller 100 may control the backrest to the set target angle through the backrest angle adjustment function (S145).

The seat controller 100 may identify whether the seat slide position of the seat S1 exists at the seat target position P1 (S150), and if the seat slide position is not the seat target position P1 (No in S150), the seat controller 100 may control the seat S1 to be moved backward to the seat target position P1 through the seat sliding function (S155).

If all the conditions of the opening of the door D1, leg rest closing, backrest target angle, and seat target position P1 of the seat S1 are satisfied through the pre-processing control (Yes in all of S123, S130, S140, and S150), the seat controller 100 may perform a side-view swivel control to swivel the seat S1 toward the outside of the vehicle (S160).

The seat controller 100 may continue the seat swivel control (No in S170) until the seat-swivel angle collected in the state data reaches a side-view swivel setting angle (for providing the rear view for example), and end the corresponding control if the seat-swivel angle reaches the swivel setting angle and the seat swivel is completed (or the seat provides the side view) (Yes in S170).

The seat controller 100 may then control the seat S1 to swivel-return to provide the front view based on the user input of the seat swivel switch 111 if receiving a signal requesting return of the seat (S190).

Also, or alternatively, if receiving a signal indicating the door D1 is closed during the pre-processing control, the seat controller 100 may stop the pre-processing control, cancel the side-view swivel request, and perform an inverted return control.

Also, or alternatively, the center console C applied to the vehicle may be the movable manual console C2 and/or electric console C3 instead of the fixed console C1. In this case, the seat controller 100 may guide the manual console C2 to be moved to the console target position P2 (see S148 in FIG. 7), and/or control the electric console C3 to be moved to the console target position P2 (see S149 in FIG. 10).

The present disclosure provides a vehicle seat control system capable of controlling smooth seat swivel. A space for seat swivel is secured via leg rest closing and seat sliding. Seat state data is identified based on a user request to swivel an electrified seat in a vehicle. A method for controlling the vehicle seat via the vehicle seat control system is provided.

According to an example, a vehicle seat control system includes: at least one seat including one or more electronic devices for a seat sliding function, a backrest angle adjustment function, a leg-rest angle adjustment function, and a seat swivel function; a seat control module disposed in each seat to collect seat state data of the corresponding seat and control the functions of the one or more electronic devices based on an applied command; and a seat controller disposed to correspond to the seat control module, predicting an obstruction condition by another component during seat swivel during seat swivel by checking the seat state data if receiving a seat swivel request from a user, removing the obstruction condition through a pre-processing control by using the seat control module, and then performing a seat swivel control.

The one or more electronic devices may include a first motor operated for the seat sliding function based on a control signal, and including a first sensor measuring a seat sliding position, a second motor operated for the backrest angle adjustment function based on a control signal, and including a second sensor measuring a backrest angle, a third motor operated for the leg-rest angle adjustment function based on a control signal, and including a third sensor measuring a leg rest angle, and a fourth motor operated for the seat swivel function based on a control signal, and including a fourth sensor measuring a seat swivel angle.

The fourth motor may perform swivel-switch by swiveling the seat in various angles and directions.

The fourth motor may swivel the seat in to a seat direction configured to provide the user with a front view, a side view, or a rear view based on the control signal.

Each of the first to fourth sensors may be a Hall sensor or an encoder, and measure the position of the corresponding motor.

The seat controller may control the function of the seat, then update, in a memory, the last seat state data received from each motor and each sensor, mounted in the seat, identify a current state data before performing the seat swivel control, and perform the pre-processing control to switch a leg rest of the seat to be closed through the leg-rest angle adjustment function if the leg rest is opened, and move the seat to a seat target position P1, where the seat is capable of being swiveled, through the seat sliding function.

The pre-processing control may further control the seat to a target angle through the backrest angle adjustment function of the seat.

The system may further include: a center console disposed between the front seats and capable of being moved forward/backward; and a console position sensor detecting a position of the center console, wherein the seat controller predicts the obstruction condition by another component including the center console during the seat swivel by further checking center console state data of the center console, removes the obstruction condition through the pre-processing control by using the seat control module, and then performs the seat swivel control.

The center console may be a manual console C2 moved by the user, and the seat controller may identify whether a position of the manual console C2 is a foremost console target position P2 during the pre-processing control, and guide the user to move the manual console C2 to the target position P2 if the position of the manual console C2 is not the console target position P2.

The center console may be an electric console C3 moved through the motor and a console controller, and the seat controller may identify whether a position of the electric console C3 is a foremost console target position P2 during the pre-processing control, and control the electric console C3 to be moved to the console target position P2 through a console controller E2 if the position of the electric console C3 is not the console target position P2.

According to another example, a method for a vehicle seat control includes: checking seat state data of a seat if receiving a signal requesting swivel of the seat based on a user switch input; identifying whether a plurality of conditions including preset conditions of leg rest closing and a seat target position P1 are satisfied based on the state date of the seat; performing a pre-processing control to remove an obstruction condition by determining the obstruction condition in operating a seat swivel function if at least one of the plurality of conditions is not satisfied; and performing a swivel control to swivel the seat at a preset angle through the seat swivel function if the pre-processing control is completed and the plurality of conditions are all satisfied.

The performing of the pre-processing control may include: identifying whether a leg rest angle of the seat is closed, and controlling the leg rest to be closed through a leg-rest angle adjustment function if the leg rest angle is not closed; and identifying whether a seat slide position of the seat is the seat target position P1, and controlling the seat to be moved backward to the seat target position through a seat sliding function if the seat slide position is not the seat target position P1.

The performing of the pre-processing control may further include identifying whether a backrest angle of the seat is a backrest target angle T, and controlling a backrest to the target angle through a backrest angle adjustment function if the backrest angle is not the backrest target angle.

In a case where a manual console C2 capable of being moved forward/backward is disposed between the front seats of a vehicle and a limit sensor detecting a position of the manual console C2 is disposed, the performing of the pre-processing control may further include identifying whether the position of the manual console C2 is a foremost console target position P2, and guiding a user to move the manual console C2 to the console target position P2 if the position of the manual console C2 is not the foremost console target position P2.

In a case where an electric console C3 capable of being moved forward/backward is disposed between the front seats of a vehicle and a sensor detecting a position of the electric console C3 is disposed, the performing of the pre-processing control may further include identifying whether the position of the electric console C3 is a foremost console target position P2, and controlling the electric console C3 to be moved to the console target position P2 through a console controller if the position of the electric console C3 is not the foremost console target position P2.

The method may further include disposing the electric console C3 at its immediately-previous usage position by controlling the electric console C3 moved to the console target position P2 to be moved backward after the performing of the swivel control.

The performing of the swivel control may include swiveling the seat in various angles and directions for the seat to be switched to a seat direction configured to provide a user with a front view, a side view, and/or a rear view.

The method may further include identifying whether a door corresponding to the seat is opened before the switching of the seat to provide the side view, and guiding the user to open the door if the door is not opened, wherein the switching of the seat to provide the side view is performed if the door corresponding to the seat is opened.

The method may further include controlling the seat to return to the front view by swiveling the seat based on the user switch input if a signal requesting return of the seat is received after the completing of the switching of the seat to provide the side view.

According to the examples of the present disclosure, it may be possible to allow the seat to be swiveled without any obstruction by the surrounding components by identifying the seat state data and adjusting the leg rest angle, the backrest angle, and the seat slide position through the pre-processing control to secure the space where the seat may be swiveled if the user requests the seat swivel.

Also, or alternatively, if the fixed console, the movable manual console or the electric console is applied to the vehicle based on its specification, it may be possible to secure the space where the seat may be swiveled via the pre-processing control including the position adjustment of the center console.

Also, or alternatively, it may be possible to apply the smooth seat swivel function without reducing the size or function of the seat by securing the space where the seat may be swiveled through the organic control based on the state data of the multi-functional electrified seat, center console or door, applied to the vehicle, if the user requests the seat swivel.

As set forth above, according to the examples of the present disclosure, it is possible to allow the seat to be swiveled without any obstruction by the surrounding components by identifying the seat state data and adjusting the leg rest angle, the backrest angle, and the seat slide position through the pre-processing control to secure the space where the seat may be swiveled if the user requests the seat swivel.

Also, or alternatively, if the fixed console, the movable manual console and/or the electric console is applied to the vehicle based on its specification, it is possible to secure the space where the seat may be swiveled through the pre-processing control including the position adjustment of the center console.

Also, or alternatively, it is possible to apply the smooth seat swivel function without reducing the size or function of the seat by securing the space where the seat may be swiveled through the organic control based on the state data of the multi-functional electrified seat, center console or door, applied to the vehicle, if the user requests the seat swivel.

The examples of the present disclosure may be implemented not only through the system and/or method described above, but also through a program for realizing a function corresponding to the configuration of the examples of the present disclosure, a recording medium in which the program is recorded, or the like. Such implementation may be easily made by those in the art to which the present disclosure pertains from the description of the examples described above.

Although the examples of the present disclosure have been described in detail hereinabove, the scope of the present disclosure is not limited thereto. That is, various modifications and alterations made by those skilled in the art by using a basic concept of the present disclosure as defined in the following claims also fall within the scope of the present disclosure.

What is claimed is:

1. A vehicle seat control system comprising:
a seat comprising at least one electronic device configured to perform a plurality of functions comprising: a seat sliding function, a backrest angle adjustment function, a leg-rest angle adjustment function, and a seat swivel function;
a seat control module, for the seat, configured to collect seat state data and to control, based on a received command, the at least one electronic device to perform at least one of the plurality of functions; and
a seat controller, communicatively connected to the seat control module, configured to:
predict an obstruction condition of a seat swivel by checking, based on receiving a request for the seat swivel, the seat state data;
resolve the obstruction condition via a pre-processing control of the seat control module; and
based on the obstruction condition being resolved, cause the seat control module to control the at least one electronic device to perform the seat swivel via the seat swivel function.

2. The system of claim 1, wherein
the at least one electronic device comprises:
a first motor configured to perform the seat sliding function, and communicatively connected to a first sensor configured to measure a seat sliding position,
a second motor configured to perform the backrest angle adjustment function, and communicatively connected to a second sensor configured to measure a backrest angle,
a third motor configured to perform the leg-rest angle adjustment function, and communicatively connected to a third sensor configured to measure a leg rest angle, and
a fourth motor configured to perform the seat swivel function, and communicatively connected to a fourth sensor measuring a seat swivel angle.

3. The system of claim 2, wherein the fourth motor is configured to perform a swivel-switch by swiveling the seat from facing a first direction to facing a second direction.

4. The system of claim 3, wherein the fourth motor is configured to swivel the seat to a seat direction configured to provide a user of the seat with a front view, a side view, or a rear view with respect to a vehicle comprising the seat.

5. The system of claim 2, wherein each of the first sensor, the second sensor, the third sensor and the fourth sensor:
comprises one or more of a Hall sensor or an encoder; and
is configured to measure a position of a corresponding motor of the first motor, the second motor, the third motor, or the fourth motor.

6. The system of claim 2, wherein the seat controller is further configured to, based on causing performance of at least one of the plurality of the functions, update, in a memory, last seat state data received from each sensor with current seat state data received from each sensor;
wherein the checking the seat state data comprises identifying the current seat state data; and
wherein the seat controller is further configured to perform the pre-processing control to cause:
based on the current seat state data indicating the leg rest angle is open, switching, via the leg-rest angle adjustment function, a leg rest angle to be closed; and
moving, via the seat sliding function, the seat to a seat target position at which the seat is capable of being swiveled.

7. The system of claim 6, wherein the performing the pre-processing control further causes adjusting, via the backrest angle adjustment function, the seat backrest to a target angle.

8. The system of claim 1, wherein the seat is a front seat, the system further comprising:
a center console disposed between the seat and an second front seat, wherein the seat and the second front seat are each capable of being moved in a direction parallel to a front-back axis of a vehicle comprising the seat; and
a console position sensor configured to detect a position of the center console,
wherein the seat controller is configured to predict, based on checking center console state data of the center console, the obstruction condition to comprise the center console obstructing the seat swivel function.

9. The system of claim 8, wherein the center console is a manual console movable by a user, and
wherein the seat controller is configured to:
determine whether a position of the manual console is a console target position, and
based on a determination that the position of the manual console is not the console target position, guide the user to move the manual console to the console target position.

10. The system of claim 8, wherein the center console is an electric console movable via a motor controlled by a console controller, and
wherein the seat controller is configured to:
determine whether a position of the electric console is a console target position; and
based on a determination that the position of the electric console is not the console target position, cause the console controller to move the electric console to the console target position.

11. A method for a vehicle seat control, the method comprising:
checking, based on receiving a signal indicating user input requesting to swivel a seat, seat state data of the seat;
determining, based on the seat state data, whether a plurality of conditions, comprising preset conditions of a closed leg rest and the seat at a target position, are satisfied;
based on at least one of the plurality of conditions not being satisfied:
determining an obstruction condition for performing a seat swivel function; and
performing a pre-processing control to remove the obstruction condition; and
based on the performing the pre-processing control and the plurality of conditions being satisfied, performing a swivel control to swivel the seat to a preset angle via the seat swivel function.

12. The method of claim 11, wherein the performing the pre-processing control comprises:
determining whether a leg rest angle of the seat is closed, and, based on determining the leg rest angle is not closed, controlling the leg rest angle to be closed via a leg-rest angle adjustment function; and
determining whether a seat slide position of the seat is the target position, and, based on determining the seat slide position is not the target position, controlling the seat to be moved to the target position via a seat sliding function.

13. The method of claim 12, wherein the performing the pre-processing control further comprises determining whether a backrest of the seat is at a target angle, and, based on determining the backrest is not at the target angle, controlling the backrest to the target angle via a backrest angle adjustment function.

14. The method of claim 11, wherein the seat is a front seat of a vehicle, and a manual console is disposed between the seat and another front seat of the vehicle;
wherein the manual console is capable of being moved manually by a user in a direction parallel to a front-back axis of a vehicle;
wherein a sensor is configured to detect a position of the manual console; and
wherein the performing of the pre-processing control further comprises determining whether the position of the manual console is a console target position, and, based on determining the position of the manual console is not the console target position, guiding a user to move the manual console to the console target position.

15. The method of claim 11, wherein the seat is a front seat of a vehicle, and an electric console is disposed between the seat and another front seat of the vehicle;
wherein the electric console is capable of being moved, via a console controller configured to control a motor of the electric console, in a direction parallel to a front-back axis of a vehicle;
wherein a sensor is configured to detect a position of the electric console; and
wherein the performing of the pre-processing control further comprises determining whether the position of the electric console is a console target position, and, based on determining the position of the electric console is not the console target position, controlling the electric console to be moved to the console target position via the console controller.

16. The method of claim 15, further comprising, after the performing of the swivel control, controlling the electric console to return from the console target position to its previous usage position.

17. The method of claim 11, wherein the performing of the swivel control comprises causing swiveling of the seat to a seat direction configured to provide a user with a front view, a side view, or a rear view.

18. The method of claim 17, further comprising:
determining whether a door corresponding to the seat is opened before the causing swiveling of the seat to the seat direction configured to provide the side view; and
based on determining the door not is not opened, guiding the user to open the door, wherein the swiveling of the seat to the seat direction configured to provide the side view is performed based on the door corresponding to the seat being opened.

19. The method of claim 18, further comprising, based on receiving a user input signal requesting return of the seat after the swiveling of the seat to the seat direction configured to provide the side view, causing swiveling of the seat to a seat direction configured to provide the front view.
